(19) United States
(12) Patent Application Publication
(10) Pub. No.: US 2025/0118329 A1
(43) Pub. Date: Apr. 10, 2025

(54) ARTIFICIAL INTELLIGENCE VIRTUAL ASSISTANT USING LARGE LANGUAGE MODEL PROCESSING

(71) Applicant: Loop Now Technologies, Inc., San Mateo, CA (US)

(72) Inventors: Edwin Chiu, Cupertino, CA (US); Jing Xian Chen, Dublin, CA (US); Shi Feng, East Palo Alto, CA (US); Jerry Ting Kwan Luk, Menlo Park, CA (US); Jeremiah Kevin Tu, Sunnyvale, CA (US); Deric Walintukan, Newark, CA (US); Ziming Zhuang, Palo Alto, CA (US)

(73) Assignee: Loop Now Technologies, Inc., San Mateo, CA (US)

(21) Appl. No.: 18/989,061

(22) Filed: Dec. 20, 2024

Related U.S. Application Data
(63) Continuation-in-part of application No. 18/820,456, filed on Aug. 30, 2024.
Application No. 18/820,456 is a continuation-in-part of application No. 18/585,212, filed on Feb. 23, 2024.
(60) Provisional application No. 63/649,966, filed on May 21, 2024.
(60) Provisional application No. 63/638,476, filed on Apr. 25, 2024.
(60) Provisional application No. 63/571,732, filed on Mar. 29, 2024.
(60) Provisional application No. 63/557,622, filed on Feb. 26, 2024.
(60) Provisional application No. 63/557,623, filed on Feb. 26, 2024.
(60) Provisional application No. 63/557,628, filed on Feb. 26, 2024.
(60) Provisional application No. 63/613,312, filed on Dec. 21, 2023.
(60) Provisional application No. 63/604,261, filed on Nov. 30, 2023.
(60) Provisional application No. 63/546,768, filed on Nov. 1, 2023.
(60) Provisional application No. 63/546,077, filed on Oct. 27, 2023.
(60) Provisional application No. 63/536,245, filed on Sep. 1, 2023.
(60) Provisional application No. 63/524,900, filed on Jul. 4, 2023.
(60) Provisional application No. 63/522,205, filed on Jun. 21, 2023.
(60) Provisional application No. 63/472,552, filed on Jun. 12, 2023.
(60) Provisional application No. 63/464,207, filed on May 5, 2023.
(60) Provisional application No. 63/458,733, filed on Apr. 12, 2023.
(60) Provisional application No. 63/458,458, filed on Apr. 11, 2023.
(60) Provisional application No. 63/458,178, filed on Apr. 10, 2023.
(60) Provisional application No. 63/454,976, filed on Mar. 28, 2023.
(60) Provisional application No. 63/447,918, filed on Feb. 24, 2023.
(60) Provisional application No. 63/447,925, filed on Feb. 24, 2023.

(51) Int. Cl. G10L 25/57; G06Q 20/20; G06T 13/40; G10L 13/027; G10L 13/033; G10L 15/04; G10L 15/183; G10L 15/22

(52) U.S. Cl. CPC G10L 25/57; G06Q 20/20; G06T 13/40; G10L 13/027; G10L 13/033; G10L 15/04; G10L 15/183; G10L 15/22

(57) ABSTRACT

Video processing using artificial intelligence is disclosed. An embedded interface including products for sale is accessed. A user requests an interaction based on one of the products. The embedded interface initiates a video segment including a synthetic human in response to the user request. The user submits a question or comment. The interface collects the user input and converts it into a dataset readable by a large language model (LLM). The LLM generates a response to the user request. The response is used to generate an audio stream. The audio stream includes simulated human speech errors and pauses. The audio stream is segmented and a video clip is synthesized for each audio segment. The video clips are assembled into a new video segment which is presented to the user. Additional user interactions are collected and new video segments are generated in response.

### RELATED APPLICATIONS

This application claims the benefit of U.S. provisional patent applications “Artificial Intelligence Virtual Assistant Using Large Language Model Processing” Ser. No. 63/613,312, filed Dec. 21, 2023, “Artificial Intelligence Virtual Assistant With LLM Streaming” Ser. No. 63/557,622, filed Feb. 26, 2024, “Self-Improving Interactions With An Artificial Intelligence Virtual Assistant” Ser. No. 63/557,623, filed Feb. 26, 2024, “Streaming A Segmented Artificial Intelligence Virtual Assistant With Probabilistic Buffering” Ser. No. 63/557,628, filed Feb. 26, 2024, “Artificial Intelligence Virtual Assistant Using Staged Large Language Models” Ser. No. 63/571,732, filed Mar. 29, 2024, “Artificial Intelligence Virtual Assistant In A Physical Store” Ser. No. 63/638,476, filed Apr. 25, 2024, and “Ecommerce Product Management Using Instant Messaging” Ser. No. 63/649,966, filed May 21, 2024.

This application is a continuation-in-part of U.S. patent application “Livestream With Large Language Model Assist” Ser. No. 18/820,456, filed Aug. 30, 2024, which claims the benefit of U.S. provisional patent applications “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, “Artificial Intelligence Virtual Assistant Using Large Language Model Processing” Ser. No. 63/613,312, filed Dec. 21, 2023, “Artificial Intelligence Virtual Assistant With LLM Streaming” Ser. No. 63/557,622, filed Feb. 26, 2024, “Self-Improving Interactions With An Artificial Intelligence Virtual Assistant” Ser. No. 63/557,623, filed Feb. 26, 2024, “Streaming A Segmented Artificial Intelligence Virtual Assistant With Probabilistic Buffering” Ser. No. 63/557,628, filed Feb. 26, 2024, “Artificial Intelligence Virtual Assistant Using Staged Large Language Models” Ser. No. 63/571,732, filed Mar. 29, 2024, “Artificial Intelligence Virtual Assistant In A Physical Store” Ser. No. 63/638,476, filed Apr. 25, 2024, and “Ecommerce Product Management Using Instant Messaging” Ser. No. 63/649,966, filed May 21, 2024.

The U.S. patent application “Livestream With Large Language Model Assist” Ser. No. 18/820,456, filed Aug. 30, 2024 is also a continuation-in-part of U.S. patent application “Synthesized Realistic Metahuman Short-Form Video” Ser. No. 18/585,212, filed Feb. 23, 2024, which claims the benefit of U.S. provisional patent applications “Synthesized Realistic Metahuman Short-Form Video” Ser. No. 63/447,925, filed Feb. 24, 2023, “Dynamic Synthetic Video Chat Agent Replacement” Ser. No. 63/447,918, filed Feb. 24, 2023, “Synthesized Responses To Predictive Livestream Questions” Ser. No. 63/454,976, filed Mar. 28, 2023, “Scaling Ecommerce With Short-Form Video” Ser. No. 63/458,178, filed Apr. 10, 2023, “Iterative AI Prompt Optimization For Video Generation” Ser. No. 63/458,458, filed Apr. 11, 2023, “Dynamic Short-Form Video Transversal With Machine Learning In An Ecommerce Environment” Ser. No. 63/458,733, filed Apr. 12, 2023, “Immediate Livestreams In A Short-Form Video Ecommerce Environment” Ser. No. 63/464,207, filed May 5, 2023, “Video Chat Initiation Based On Machine Learning” Ser. No. 63/472,552, filed Jun. 12, 2023, “Expandable Video Loop With Replacement Audio” Ser. No. 63/522,205, filed Jun. 21, 2023, “Text-Driven Video Editing With Machine Learning” Ser. No. 63/524,900, filed Jul. 4, 2023, “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, and “Artificial Intelligence Virtual Assistant Using Large Language Model Processing” Ser. No. 63/613,312, filed Dec. 21, 2023.

Each of the foregoing applications is hereby incorporated by reference in its entirety.

### FIELD OF ART

This application relates generally to video processing and more particularly to an artificial intelligence virtual assistant using large language model processing.

### BACKGROUND

Ever since bartering and trading began, the selling of products has been both an art and a science. Selling goods and services successfully requires a combination of various skills, strategies, and techniques which must be updated to keep pace with buyers across differing markets. Whether selling online or in person to consumers or businesses, a salesperson must know how to attract, persuade, and satisfy customers. One of the first steps in selling products is to identify the target market—the group of people most likely to make a purchase. The successful salesperson needs to understand customer needs, wants, challenges, goals, preferences, and behaviors. This allows the tailoring of products, pricing, promotion, and distribution to suit the buyers' specific requirements and expectations. Various methods such as surveys, interviews, focus groups, online analytics, and competitor analysis can be used to research target markets. By segmenting the market into smaller groups based on common characteristics, buyer personas can be generated. These are fictional representations of ideal customers which guide marketing and sales efforts.

In some sales and marketing strategies, a unique value proposition can be produced. A unique value proposition (UVP) is a statement that summarizes the main benefit or value that a product offers customers, and describes how the product differs from the competition. It answers the question, “Why should I buy from you?” A good UVP should be clear, concise, specific, and relevant to the target market. It should also highlight competitive advantages, unique features, and benefits that set the product apart from rivals. It should communicate why the product is the best one for the customer. Closely related to the UVP is a sales pitch. A sales pitch is a presentation or a conversation that aims to persuade potential customers to buy a product. It should be based on the UVP and tailored to the customers' needs and interests. A good sales pitch should have a hook, which is an attention-grabbing statement or question that sparks curiosity and interest in the product. A good sales pitch also needs to point out a problem. A problem is a challenge that the customer is facing and that the product can solve, for example, “Energy prices are continuing to climb, and winter is just around the corner.” The solution to the problem is a description of how the product can address the problem and provide value to the customers. In this example, a proposed solution could include a statement such as “Our new lightbulbs can help you reduce your energy consumption and save money by automatically providing superior lighting for less than 50% wattage.”

A good sales pitch also includes a proof. A proof is evidence or a testimonial that supports the claims of the product and builds trust. For example, customers from both homes and offices can talk about how much money they have saved since switching to the new lightbulbs, or how satisfied employees are in their better lit offices. Finally, the sales pitch must include a call to action. The call to action tells the customer in clear and specific terms what to do next. In this instance, a call to action can state “If you want to save money on your next monthly electric bill, order a package of our lightbulbs and get 20% off your first order.” Selling products is a complex and challenging task that requires planning, preparation, and practice. Creating a unique value proposition and sales pitch can improve the chances of success and increase sales performance, regardless of the product being offered or the market being worked.

### SUMMARY

Consumers like to work with people who are like them when making purchases or learning about products and services. Customers and users, whether in person or online, look to find people whom they admire and can relate to when buying clothes, tools, computers, groceries, or anything else. Stores and websites recognize this and work to find sales representatives, help desk staff, product experts, wait staff, IT staff, and even custodians and bellmen who can connect with and relate to their customers. Every interaction can either move a customer toward liking their company, and thus being more likely to buy their products, or toward disliking their company, and buying goods and services from a different company. Good salespeople and support staff invest the effort required to know their customers and relate to them. The short-term relationships they form with consumers helps them to elicit information that can ultimately lead to closing a sale or even increasing the number and quality of items purchased. In many cases, customers who connect well to salespeople or support staff will ask for them again when they return to make additional purchases. This is the gold standard for employees who deal with the public in any company, large or small-creating relationships that encourage customers to connect and purchase their goods and services again and again.

A computer-implemented method for video processing is disclosed. An embedded interface including products for sale is accessed. A user requests an interaction based on one of the products. The embedded interface initiates a video segment including a synthetic human in response to the user request. The user submits a question or comment. The interface collects the user input and converts it into a dataset readable by a large language model (LLM). The LLM generates a response to the user request. The response is used to generate an audio stream. The audio stream includes simulated human speech errors and pauses. The audio stream is segmented and a video clip is synthesized for each audio segment. The video clips are assembled into a new video segment which is presented to the user. Additional user interactions are collected and new video segments are generated in response.

A computer-implemented method for video processing is disclosed comprising: accessing an embedded interface, wherein the embedded interface includes one or more products for sale; requesting, by a user, an interaction, wherein the interaction is based on a product for sale within the one or more products for sale; displaying, within the embedded interface, a first video segment, wherein the first video segment includes a synthetic human, and wherein the first video segment initiates the interaction; collecting, by the embedded interface, user input; converting the user input, wherein the converting results in a dataset, wherein the dataset is readable by a large language model (LLM); creating, by the LLM, a response to the interaction with the user; producing a second video segment, wherein the second video segment includes a performance by the synthetic human, wherein the performance includes the response that was created; and presenting, within the embedded interface, the second video segment that was synthesized. In embodiments, the second video segment includes a synthesized voice for the synthetic human. In embodiments, the synthesized voice is based on AI-generated speech, wherein the AI-generated speech includes the response that was created. In embodiments, the AI-generated speech comprises an audio stream. Some embodiments comprise adding, to the audio stream, one or more simulations of human speech errors. In embodiments, the audio stream includes pauses to simulate human cognitive processing rates.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for an artificial intelligence virtual assistant using large language model processing.

FIG. 2 is a flow diagram for an artificial intelligence virtual assistant using large language model processing.

FIG. 3 is an infographic for a customized video playlist with machine learning.

FIG. 4 is an example of displaying a first video segment.

FIG. 5 is an example of an interaction with an artificial intelligence virtual assistant.

FIG. 6 is an example of processing an audio stream.

FIG. 7 is an example of an ecommerce purchase environment.

FIG. 8 is a system diagram for an artificial intelligence virtual assistant using large language model processing.

### DETAILED DESCRIPTION

Customers generally prefer to purchase goods and services from people they can relate to, or whom they can look up to, admire, and trust. For many people, this means they look for staff people who look, talk, and behave in ways similar to themselves. While this is not always the case, even when a salesperson or help desk person looks or sounds different, most customers look for points of similarity, ways in which they can relate to the person with whom they are working. Good salespeople and support staff recognize this tendency and work to build bridges of commonality with their customers. They ask questions to get information about the customer or user of their products so that they can select items best suited to the customer's needs. They look for discounts, sales, and other purchasing advantages in order to accommodate the customer and increase sales for their employers. They know their products and how best to describe and demonstrate their wares in order to facilitate sales that will benefit both the company and the customer. If a sales representative builds rapport with a customer, the customer may ask to interact with that same representative for future needs or purchases.

A challenge for the company with products to sell is finding and retaining knowledgeable and engaging sales and support staff. Finding the right people, training them, compensating them, and making sure that they are available is a time-consuming, expensive, ongoing effort. As the company grows and the number of products expands, effective and continued training and support efforts are vital. As the number and sizes of customer groups expand, so does the variety of wants and desires expressed by the customer base. Keeping up with these demands and making excellent company representatives available around the clock present ongoing challenges.

Techniques for video processing are disclosed. An embedded interface is installed on a website or in an application that can run on a computer or mobile device. The interface allows the operators to display and sell products and services. A user can request an interaction with sales or support staff within the embedded interface. The interaction can be relevant to a particular product or can be a more general request for help in finding the right product or service. The embedded interface collects information about the user from a video, text, or audio chat accessed by the user. This user information can be combined with additional data about the user from previous interactions, social media platforms, search engines, and so on. The user information is analyzed by an AI machine learning model and is used to select a synthetic human to act as the requested sales or support person. The synthetic human initiates an exchange with the user, generally by asking a question such as “May I help you?” User information continues to be collected as the user responds to and interacts with the synthetic human representative. Questions and comments generated by the user are collected and analyzed by the AI machine learning model. The AI model includes large language model (LLM) processing and natural language processing (NLP), so that the questions and comments can be interpreted and the responses to the user seem natural. A dataset with information articles and questions covering the products for sale offered by the website is accessed by the AI machine learning model and an answer is generated in the form of text. The text takes the form of a script which the synthetic human can perform. The LLM can add lifelike pauses and errors into the script so that when the synthetic human performs it, the resulting audio closely resembles normal human conversation. Once the script has been recorded using the voice of the synthetic human, the resulting audio stream is broken up into segments based on the natural auditory cadence of the stream. Each audio segment is submitted to one or more processors and is used to generate a video clip of the synthetic human performing the audio segment. Parallel processing of the audio segments allows video clips to be produced rapidly, assembled, and presented to the user in a timely manner. A game engine with rig controls can be used to generate and refine movements of the synthetic human's body, face, mouth, lips, and eyes so that it speaks and moves in a human fashion. The synthetic human can be seen as a head, an upper body, a complete 3D human, and so on. The synthetic human can demonstrate a product such as a vacuum cleaner, tennis racket, kitchen mixer, or whiteboard. Additional short-form videos can be shown along with the synthetic human to demonstrate products or show various options. Clothing and accessories can be worn by the synthetic human to display items the customer is considering, or to advertise products for sale. The result is that the user interacts with the synthetic human as he or she would a real-life sales or support staff person. An ecommerce environment can be added to the embedded interface so that users can purchase products and services as they interact with the synthetic human. Each interaction is recorded by the AI machine learning model to refine the performance of the synthetic humans and to learn more about each customer for future interactions. Thus, knowledgeable and relatable sales and support staff are available at any time, day or night, ready to sell and support a broad range of products and services offered by a website or sales outlet.

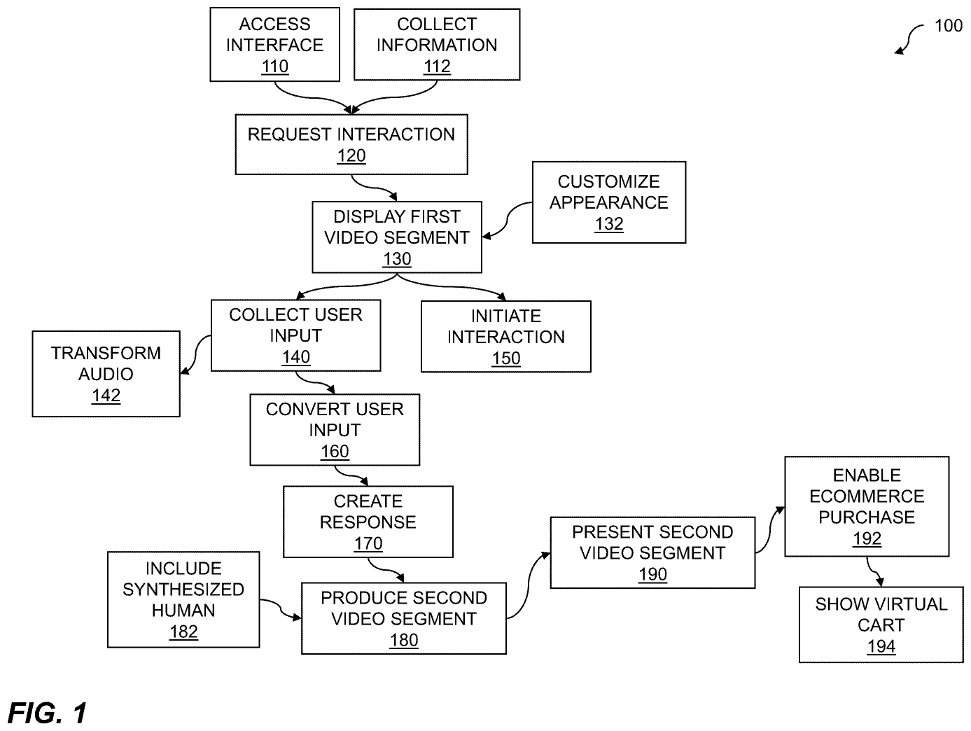

FIG. 1 is a flow diagram for an artificial intelligence virtual assistant using large language model processing. The flow 100 includes accessing 110 an embedded interface, wherein the embedded interface includes one or more products for sale. In embodiments, the embedded interface can comprise a website. The website can be an ecommerce site for a single vendor or brand, a group of businesses, a social media platform, and so on. In embodiments, the website can be displayed on a portable device. The portable device can be an Over-the-Top (OTT) device such as a mobile phone, laptop computer, tablet, or pad. The accessing of the website can be accomplished using a browser running on the device. In embodiments, the embedded interface comprises an app running on a mobile device. The app can use HTTP, TCP/IP, or DNS to communicate with the Internet, web servers, cloud-based platforms, and so on.

The flow 100 further includes collecting 112, from the user, demographic information. In embodiments, information about a user can be collected as the user views website pages displayed by the embedded interface. The demographic information can include gender, age, skin color, racial characteristics, vocal qualities, clothing, accessories, and so on. In some embodiments, additional user information including previous website history, chat texts, voice interactions, video usage information, clicks on website pages, time spent on website pages, searches initiated by the user, previous purchase information, and so on can be gathered from data stored on websites, search engines, and social media platforms. The collected user information can be analyzed by an artificial intelligence (AI) machine learning model. In embodiments, an AI machine learning model can be trained to recognize ethnicity, sex, age, etc. The AI machine learning model can access a library of images of individuals that can be used as synthetic hosts. The library of images can include options of ethnicity, sex, age, hair color and style, clothing, accessories, etc. The synthetic host that is selected by the AI machine learning model can be matched with the demographic information that was collected. For example, if based on previous purchase history, the AI machine learning model determines that there is a high probability that the user is a woman with a history of purchasing makeup, a synthetic human model wearing makeup can be selected.

The flow 100 includes requesting 120, by a user, an interaction, wherein the interaction is based on a product for sale within the one or more products for sale. In embodiments, the user can request an interaction by clicking on an icon or button displayed in the embedded interface, clicking on a help button on a webpage, asking for help in a text chat box, navigating to a help desk screen, pressing a phone button during a call, submitting an email to a help desk address, and so on. The user can initiate an interaction from the main webpage of a website, a help menu page, a webpage presenting a specific product, a text or video chatbot embedded in the website, and so on.

The flow 100 includes displaying 130, within the embedded interface, a first video segment, wherein the first video segment includes a synthetic human, wherein the first video segment initiates 150 the interaction. In embodiments, the first video segment displays the synthetic human initiating a response to the user interaction request. For example, the synthetic host can be animated to say, “How may I help you?” or “Good day! What can I do for you?” In these cases, the first video segment can be pre-synthesized and ready to be displayed to the user. In other cases, for instance where the user has asked for help from a specific product webpage, the initial synthetic human interaction can be customized. For example, a video segment including the synthetic human can be created, wherein the synthetic human is animated to say, “Hello. I see that you are looking at our universal cooking pot. What questions can I answer for you?”

In embodiments, the synthetic human can be based on the user information collected by the embedded interface. An image of a live human can be captured from media sources including one or more photographs, videos, livestream events, and livestream replays, including the voice of the livestream host. In some embodiments, a photorealistic representation of a help desk representative, salesperson, or livestream host can include a 360-degree representation. A human host can be recorded with one or more cameras, including videos and still images, and microphones for voice recording. The recordings can include one or more angles of the human host and can be combined to comprise a dynamic 360-degree photorealistic representation of the human host. The voice of a human host can be recorded and included in the synthetic human representation. The images of the live human can be isolated and combined in an AI machine learning model into a 3D model that can be used to generate a video segment in which the synthetic human responds to the user request using answers generated by a large language model (LLM). In embodiments, a game engine can be used to generate a series of animated movements, including basic actions such as sitting, standing, holding a product, presenting a video or photograph, describing an event, and so on. Specialized movements such as facial expressions can be programmed and added to the animation as needed. Dialogue can be added so that the face of the presenter moves appropriately as the words are spoken. The result can be a performance by the synthetic human, combining animation generated by a game engine and the 3D model of the individual, including the voice of the individual. In some embodiments, the synthetic human can be a representation of an animated character.

The flow 100 further includes customizing 132 an appearance of the synthetic human, wherein the customizing is based on the demographic information that was collected. In embodiments, the various elements of the user demographics, including sex, age, race, and so on, can be used by the AI machine learning model to select and customize the appearance of the synthetic human. The synthetic human is chosen to encourage the user to interact with the synthetic human and to be motivated to purchase products that are presented and discussed during the interaction. The customizing can include age, sex, race, hair color and style, clothing, accessories, facial hair, eyewear, and so on. In embodiments, the voice of the synthetic human can be customized, including the tone, pitch, accent, rhythm, and use of idioms. In some embodiments, the AI machine learning model customizes the voice and appearance of the synthetic human based on previous interactions with human and synthetic hosts of livestreams, sales associates, frequently watched social media influencers, and so on, as well as the demographics of the user. The customizing can be based on a previous successful sale. For example, if the user has purchased an item from a specific avatar (synthetic human) previously, that same or a similar avatar can be used for the current user interaction.

The flow 100 includes collecting 140, by the embedded interface, user input. In embodiments, the user input comprises text. The user can respond to the synthetic human by typing a question or comment into a chat text box. The text box can be generated by the website or the embedded interface window. The user input can comprise audio input. In some embodiments, the audio input is included in a video chat. The user can speak to a video chat window using a mobile phone, pad, tablet, computer, microphone, and so on. The collecting further includes transforming 142 the audio input into text, wherein the transforming is accomplished with a speech-to-text converter. Regardless of the method selected by the user, the response is transformed 142 into text that can be fed into a large language model (LLM).

The flow 100 includes converting 160 the user input, wherein the converting results in a dataset, wherein the dataset is readable by a large language model (LLM). A large language model is a type of machine learning model that can perform a variety of natural language tasks, including generating and classifying text, answering questions in a human conversational manner, and translating text from one language to another. The LLM database can include audio and text viewer interactions between the user and the synthetic human. The LLM can include natural language processing (NLP). NLP is a category of artificial intelligence (AI) concerned with interactions between humans and computers using natural human language. NLP can be used to develop algorithms and models that allow computers to understand, interpret, generate, and manipulate human language. NLP includes speech recognition; text and speech processing; encoding; text classification, including text qualities, emotions, humor, and sarcasm, and classifying it accordingly; language generation; and language interaction, including dialogue systems, voice assistants, and chatbots. In embodiments, the LLM includes NLP to understand the text and the context of voice and text communication during the interaction. NLP can be used to detect one or more topics discussed by the user and synthetic human. Evaluating a context of the interaction can include determining a topic of discussion; understanding references to and information from other websites; understanding products for sale or product brands; assessing livestream hosts associated with a brand, product for sale, or topic; and so on.

The flow 100 includes creating 170, by the LLM, a response to the interaction with the user. In embodiments, information on products presented on a website can be analyzed by a machine learning model and can be used to generate answers to questions and comments related to products and services offered for sale. Datasets of questions and answers can be arranged using various data schemes, including the Stanford Question Answering Dataset (SQUAD), WikiQA, SelQA, InfoQA, and so on. These datasets are used to train machine learning models to analyze questions regarding products, services, and other subjects, and to generate suitable answers based on information articles supplied on those subjects. In embodiments, the dataset used by the LLM conforms to a SQUAD format. Answers generated by the LLM are scored based on their correctness. A correct answer must address the question actually asked by the user and provide the appropriate information based on the information article related to the product or service involved. In some embodiments, questions that cannot be interpreted by the LLM, or that generate answers that have a low likelihood of being correct, can be forwarded to a human sales associate, product expert, support staff person, and so on. The human associate can view the question generated by the user and submit an answer in text to the LLM. The LLM can record the answer in its dataset for future use, as well as submit the answer to the present user.

The flow 100 includes producing a second video segment 180, wherein the second video segment includes a performance by the synthetic human 182, wherein the performance includes the response that was created. In embodiments, the producing is based on a game engine. As discussed earlier and throughout, a game engine is a set of software applications that work together to create a framework for users to build and create video games. They can be used to render graphics, generate and manipulate sound, create and modify physics within the game environment, detect collisions, manage computer memory, and so on. In embodiments, the game engine can include a Character Movement Component that provides common modes of movement for 3D humanoid characters including walking, falling, swimming, crawling, and so on. These default movement modes are built to replicate by default and can be modified to create customized movements, such as demonstrating a product. Facial features can be edited to appear more lifelike, including storing unique and idiosyncratic elements of a human face. Articles of clothing can be similarly edited to perform as they do in real life. Lighting presets can be used to place individual characters in photorealistic environments so that light sources, qualities, and shadows appear lifelike. Voice recordings can be used to generate dialogue with the same vocal qualities used in the first video segment. Volume, pitch, rhythm, frequency, and so on can be manipulated within the game engine to create realistic dialogue for the 3D model of the synthetic human.

In embodiments, the text of the response to the user generated by the LLM is used to create a set of video clips including the synthesized human performing the response. As described in detail below, the text response to the user can be used to create an audio stream using the voice of the synthesized human selected for the first video segment. The audio stream can be separated into smaller segments based on natural language processing (NLP) analysis. Each audio segment is used to produce a video clip of the synthesized human performing the audio segment. Based on the content of the audio, the synthesized human can hold up and demonstrate a product, show the product at different angles, describe various ways of using the product, place the product on the synthetic head or body, and so on. The audio segments can be sent to multiple processors to increase the rate at which video clips are produced and assembled into a second video segment 180.

The flow 100 includes presenting 190, within the embedded interface, the second video segment that was synthesized. The embedded interface displays the assembled video segment performed by the synthetic human in a webpage window, video chat window, etc. In embodiments, as the user views the second video segment, the creating, the producing, and the presenting include a second interaction. The user can continue to interact with the synthetic human, generating additional input collected by the embedded interface. The collecting of user input, creating a response, producing audio segments and related video clips, and presenting to the user continues, so that the interaction between the user and the synthetic human appears as natural as two humans interacting within a video chat. In other embodiments, the voice of the synthetic human is heard in a phone call or text chat box. The conversation between the user and the synthetic human continues in the same way, with the LLM analyzing input from the user and responding with text replies performed by the voice of the synthetic human.

In embodiments, the rendering includes enabling 192 an ecommerce purchase, within an ecommerce environment, of the at least one additional product for sale, wherein the enabling is accomplished within at least one video in the video playlist. In embodiments, the enabling can include representing the one or more products for sale in an on-screen product card. The ecommerce purchase can include a virtual purchase cart. The ecommerce purchase can include showing 194, within a short-form video or livestream, the virtual purchase cart. In embodiments, the virtual purchase cart can cover a portion of the video or livestream. A livestream host can demonstrate, endorse, recommend, and otherwise interact with one or more products for sale. An ecommerce purchase of at least one product for sale can be enabled to the viewer, wherein the ecommerce purchase is accomplished within the video window. As the host interacts with and presents the products for sale, a product card representing one or more products for sale can be included within a video shopping window. An ecommerce environment associated with the video can be generated on the viewer's mobile device or other connected television device as the rendering of the video progresses. The ecommerce environment on the viewer's mobile device can display a livestream or other video event and the ecommerce environment at the same time. A mobile device user can interact with the product card in order to learn more about the product with which the product card is associated. While the user is interacting with the product card, the livestream video continues to play. Purchase details of the at least one product for sale can be revealed, wherein the revealing is rendered to the viewer. The viewer can purchase the product through the ecommerce environment, including a virtual purchase cart. The viewer can purchase the product without having to “leave” the livestream event or video. Leaving the livestream event or video can include having to disconnect from the event, open an ecommerce window separate from the livestream event, and so on. The video can continue to play while the viewer is engaged with the ecommerce purchase. In embodiments, the video or livestream event can continue “behind” the ecommerce purchase window, where the virtual purchase window can obscure or partially obscure the livestream event. In some embodiments, the synthesized video segment can display the virtual product cart while the synthesized video segment plays. The virtual product cart can cover a portion of the synthesized video segment while it plays.

Various steps in the flow 100 may be changed in order, repeated, omitted, or the like without departing from the disclosed concepts. Various embodiments of the flow 100, or portions thereof, can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

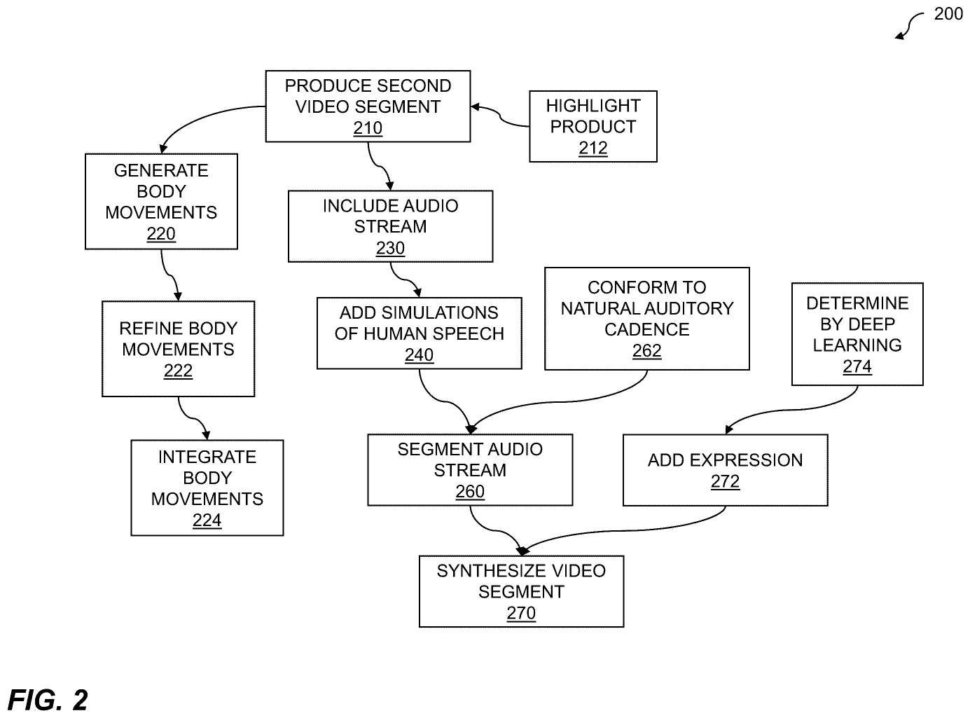

FIG. 2 is a flow diagram for producing a video segment. The flow 200 includes producing 210 a second video segment, wherein the second video segment includes a performance by the synthetic human, wherein the performance includes the response that was created. As described above and throughout, a user can interact with a synthetic human through a video chat included in an embedded interface. The embedded interface can be a website or an app running on a mobile device. The website or mobile device app are designed to display, provide information about, and sell products and services. Responses from the user can be collected by the embedded interface and converted into text input for a large language model (LLM). In embodiments, the second video segment includes text. The LLM can create a response to the interaction with the user based on information regarding the products and services for sale. In embodiments, the LLM response is created in a text format. In embodiments, the second video segment comprises highlighting 212, within the performance by the synthetic human, the product for sale. For example, the initial user question can be “What colors do these mittens come in?” The information regarding the colors available can be located by the LLM from a text description of the product located in its dataset. The LLM can also search for discounts, sales, specials, and other incentives that encourage the user to purchase. For example, the LLM response can be “These mittens come in red, navy blue, light blue, green, and black. Today, there is a special on these mittens! They are 20% off-normally $60 a pair, but now only $48! Which color would you like?”

In embodiments, the producing includes generating 220, by a generative artificial intelligence model, one or more body movements for the synthetic human. A generative artificial intelligence (AI) model is a machine learning system that can create new data or content that resembles its training data. In embodiments, the generative AI model can generate body movements for a graphical representation of a human character or avatar. A dataset of videos displaying basic body movements such as walking, running, talking, picking up an object, sitting down, standing up, etc. can be used as training data. The generative AI model can generate the same body movements for one or more generic human character avatars.

In embodiments, the producing further comprises refining 222 the one or more body movements, wherein the refining is based on one or more game engine rig controls. A game engine rig control is a tool that allows an operator to manipulate the movement and pose of a character or an object in a game engine. A rig control is usually a graphical interface that consists of handles, sliders, buttons, and other widgets that can be used to adjust the parameters of a rig, such as the position, rotation, scale, and deformation of bones, joints, and meshes. A rig control can be used to create facial expressions. The game engine rig controls allow the body movements generated by the AI model to be more finely controlled and altered. Up-close views of a head and shoulders can be refined with the game engine so that mouth, lip, face, and eye movements match those of a human speaking, showing expressions and so on. The game engine rig controls allow body movements to appear more natural and fluid, so that when a 3D human avatar character sits, stands, shows an object such as a product for sale, demonstrates a vacuum cleaner, wears a particular clothing item, etc., the appearance is lifelike.

In embodiments, the producing further comprises integrating 224, into the performance by the synthetic human, the one or more body movements that were generated. Once a set of human avatar movements has been generated and enhanced using game engine rig controls, those movements can be applied to the synthetic human displayed in one or more video segments as it interacts with the user. As more videos are added to the generative AI model with specific detailed movements, the body movements generated by the AI model can be better refined and matched to the requirements of the synthetic human product descriptions and demonstrations. Up-close videos showing a human speaking can be used to produce more lifelike video segments of synthetic humans speaking, and so on.

The flow 200 includes the second video segment, featuring a synthesized voice for the synthetic human. The synthesized voice can be based on a voiceprint from a human. In some embodiments, the synthesized voice is based on AI-generated speech, wherein the AI-generated speech includes the response that was created. In embodiments, the AI-generated speech comprises an audio stream 230. The voice used by the synthetic human in the first video segment is used to generate an audio stream 230 of the entire text response created by the LLM. The customization used with the first video segment, including tone, pitch, accent, rhythm, and so on, can be applied to the audio stream.

The flow 200 further includes adding 240, to the audio stream, one or more simulations of human speech errors. The audio stream can include pauses to simulate human cognitive processing rates. Humans do not speak perfectly with each other. Their speech includes filler words such as “um”, “ah”, “uh”, and so on. These pauses are often used to give the speaker time to assemble their thoughts or correctly phrase a sentence. Humans also make errors when they speak. They use the wrong words, get words in the wrong order, mispronounce, slur, speak too quickly or too slowly, mumble, and so on. They make grammar mistakes, such as confusing “may” and “might”, placing adjectives in the wrong order, using pronouns such as “me” and “my” incorrectly, and so on. In embodiments, the LLM adds simulations of speech errors and pauses into the user response audio stream in order to match human speech more closely. Filler words are added, words are duplicated at the beginning of phrases, the pace of speech slows down or speeds up slightly during the audio stream, and so on. In embodiments, the number of pauses and errors added to the audio stream is regulated in order to make sure that the primary content of the response is preserved and communicated to the user.

The flow 200 further includes segmenting 260 the audio stream, wherein the segmenting is based on a natural language processing (NLP) engine, wherein the segmenting results in a plurality of audio segments. In embodiments, the segmenting conforms 262 to a natural auditory cadence. Natural auditory cadence refers to the rhythmic pattern of sound and movement in human activities, such as speech, music, or sports. It is the natural synchronization of sound and movement that gives a sense of harmony and flow. For example, variations in volume, speed, and diction as a person speaks can give the listener a sense of the speaker's emotion and attitude. Humor, grief, sarcasm, devotion, admiration, and so on are often communicated by variations in natural auditory cadence, as well as vocabulary and grammar. In embodiments, responses generated by the LLM for a user interested in purchasing products are primarily informative and sales oriented in nature and intent. Words are spoken clearly and with a positive tone. Idioms can be included, but may be followed up with clarifying statements to emphasize a point. Slang may be used to match the user's speech pattern, and so on. Once the audio stream has been modified, it is broken into smaller segments based on the auditory cadence of the entire stream. Each sentence can be segmented into smaller sections based on phrasing, word emphasis, the position of a word in the sentence, and so on. The order of the segments is recorded so that as the segments are synthesized into video clips, they can be sequenced in the correct order.

In embodiments, the producing comprises synthesizing 270, for each audio segment in the plurality of audio segments, a video clip, wherein the synthesizing results in a plurality of video clips, wherein the second video segment comprises the plurality of video clips that were synthesized. In embodiments, each audio segment can be forwarded to a separate processor or group of processors that have a copy of the 3D image of the synthetic human and also have access to a game engine. The image of the synthetic human is combined with the synthesized voice and used to generate a video clip of the synthetic human performing the audio segment. In embodiments, the synthesizing is based on phoneme mapping, wherein the phoneme mapping determines a mouth and lip position of the synthetic human. A phoneme is a discrete sound that is associated with a letter of the alphabet. Some letters have more than one associated phoneme. Phonemes can also be associated with letter combinations, such as “th”, “qu”, “ing” and so on. In embodiments, each audio segment can be broken down into phonemes. Phonemes can be mapped to corresponding face, mouth, lip, and eye movements so that as a word is spoken by the synthetic human, the movement of the mouth, lip, face, and eyes correspond. Thus, the synthetic human appears to be speaking the words contained in the audio segment as naturally as a real human does. Speech errors and pauses added by the LLM are included in the video clip. For example, when the synthetic human pauses to “think” in the midst of a sentence, the eyes look down and to the right or up at the ceiling, along with slight tilts of the head, to simulate the process of thinking.

The synthesizing includes adding 272 an expression to the synthetic human, wherein the adding is based on one or more patterns of human speech, wherein the one or more patterns of human speech are determined 274 by a deep learning algorithm. A deep learning algorithm is a machine learning algorithm that uses multiple layers of artificial neural networks to learn from data and perform complex tasks. Deep learning algorithms can extract high-level features from raw inputs, such as images, text, or speech, and can use them for various applications, such as computer vision, natural language processing, speech recognition, and more. An AI machine learning model can use one or more deep learning algorithms to analyze and match facial movements, body movements, and speech patterns to previously recorded examples of various expressions. Video clips highlighting various emotions and other expressions can be recorded and analyzed to note movements in the face, eye, mouth, and lips associated with each expression or emotional state. This information can be used to produce a synthetic human performance that matches the content of the audio stream and produces a more realistic presentation in the video clip. For example, the audio segment can include informing the user of a discount available on a product. The synthetic human can be made to look surprised, happy, or excited based on the speech pattern included in the audio segment. As video clips are completed, they are assembled in the order of the complete audio stream and are ready to present to the user.

Various steps in the flow 200 may be changed in order, repeated, omitted, or the like without departing from the disclosed concepts. Various embodiments of the flow 200, or portions thereof, can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

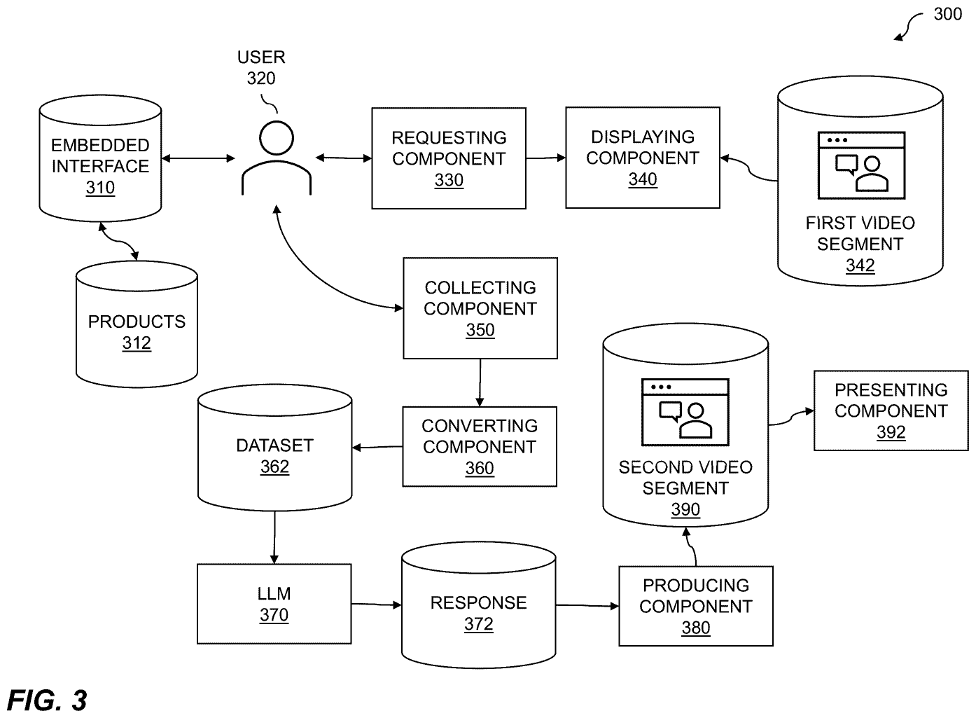

FIG. 3 is an infographic for an artificial intelligence virtual assistant using large language model processing. The infographic 300 includes accessing an embedded interface 310, wherein the embedded interface includes one or more products 312 for sale. In embodiments, the embedded interface can comprise a website. The website can be an ecommerce site for a single vendor or brand, a group of businesses, a social media platform, and so on. In embodiments, the website can be displayed on a portable device. The portable device can be an Over-the-Top (OTT) device such as a mobile phone, laptop computer, tablet, or pad. The accessing of the website can be accomplished using a browser running on the device. In embodiments, the embedded interface comprises an app running on a mobile device. The app can use HTTP, TCP/IP, or DNS to communicate with the Internet, web servers, cloud-based platforms, and so on. The database of products 312 for sale can include information such as product images, product specifications, pricing, availability, links to ecommerce sites associated with products, and/or other suitable information. The product database can be used as training data for the large language model.

The infographic 300 includes a requesting component 330. The requesting component 330 includes requesting, by a user 320, an interaction, wherein the interaction is based on a product for sale within the one or more products 312 for sale. In embodiments, the user can request an interaction by clicking on an icon or button displayed in the embedded interface, clicking on a help button on a webpage, asking for help in a text chat box, navigating to a help desk screen, pressing a phone button during a call, submitting an email to a help desk address, and so on. The user can initiate an interaction from the main webpage of a website, a help menu page, a webpage presenting a specific product, a text or video chatbot embedded in the website, and so on.

The infographic 300 includes a displaying component 340. The displaying component 340 includes displaying, within the embedded interface 310, a first video segment 342, wherein the first video segment includes a synthetic human, and wherein the first video segment initiates the interaction. In cases where the user has asked for help from a specific product webpage, the initial synthetic human interaction can be tailored to the webpage. The synthetic human is based on the user information collected by the embedded interface. The synthetic human can be based on a photorealistic representation of a help desk representative, salesperson, livestream host, etc. Composite images generated by an AI machine learning model or images of a live human can be isolated and combined in an AI machine learning model to generate a synthetic human. The first video segment can display the synthetic human performing a response generated by a large language model (LLM). For example, the synthetic human can appear in the first video segment by saying, “Good morning! How can I help you today?”

In embodiments, a game engine can be used to generate a series of movements, including basic actions such as sitting, standing, holding a product, presenting a video or photograph, describing an event, and so on. Specialized movements can be programmed and used to refine the synthetic human performance as needed. Dialogue can be added so that the face, mouth, and lips of the synthetic human move appropriately as the words are spoken. The result is a performance by the synthetic human, combining movements generated by a game engine and a 3D model of the synthetic human, including a synthetic voice selected to complement the demographics of the user. In some embodiments, the synthetic human can be a representation of an animated character.

The infographic 300 includes a collecting component 350. The collecting component 350 includes collecting, by the embedded interface 310, user input. In embodiments, information about a user can be collected as the user views website pages displayed by the embedded interface. The demographic information can include gender, age, skin color, racial characteristics, vocal qualities, clothing, accessories, and so on. In some embodiments, additional user information including previous website history, chat texts, voice interactions, video usage information, clicks on website pages, time spent on website pages, searches initiated by the user, and previous purchase information can be gathered from data stored on websites, search engines, and social media platforms. The collected user information can be analyzed by an artificial intelligence (AI) machine learning model. In embodiments, an AI machine learning model can be trained to recognize ethnicity, sex, age, etc. The AI machine learning model can access a library of images of individuals that can be used as synthetic hosts. The library of images can include options of ethnicity, sex, age, hair color and style, clothing, accessories, etc.

The infographic 300 includes a converting component 360. The converting component 360 includes converting the user input, wherein the converting results in a dataset 362, wherein the dataset is readable by a large language model (LLM) 370. In embodiments, the LLM database can include audio and text viewer interactions between the user and the synthetic human. The LLM includes natural language processing (NLP). The LLM uses NLP to understand the text and the context of voice and text communication during the interaction. In embodiments, NLP is used to detect one or more topics discussed by the user and synthetic human. Evaluating a context of the interaction can include determining a topic of discussion; understanding references to and information from other websites; understanding products for sale or product brands; and assessing livestream hosts associated with a brand, product for sale, or topic.

The infographic 300 includes creating, by the LLM 370, a response 372 to the interaction with the user. In embodiments, information on products presented on a website can be analyzed by a machine learning model and used to generate answers to questions and comments related to products and services offered for sale. The AI machine learning dataset 362 used by the LLM conforms to a SQUAD format. The SQUAD dataset format consists of questions and answers generated from information articles on products and services sold on the website. Responses 372 generated by the LLM provide the appropriate product information stated in a language style and manner consistent with the analysis of the collected user data. In some embodiments, questions that cannot be interpreted by the LLM or that generate answers that have a low likelihood of being correct can be forwarded to a human sales associate, product expert, support staff person, and so on. The human associate can view the question generated by the user and submit an answer to the LLM. The LLM can record the answer in its dataset for future use, and can submit the answer to the present user.

The infographic 300 includes a producing component 380. The producing component 380 includes producing a second video segment 390, wherein the second video segment includes a performance by the synthetic human, wherein the performance includes the response that was created. In embodiments, the producing is based on a game engine. In embodiments, the game engine can include a component that provides common modes of movement for 3D humanoid characters including walking, falling, swimming, crawling, and so on. These default movement modes are built to replicate by default and can be modified to create customized movements, such as demonstrating a product. Game engine rig controls can edit facial features to appear more lifelike, including storing unique and idiosyncratic elements of a human face. Articles of clothing can be edited to perform as they do in real life. Voice recordings can be used to generate dialogue with the same vocal qualities used in the first video segment. Volume, pitch, rhythm, frequency, and so on can be manipulated within the game engine to create realistic dialogue for the 3D model of the synthetic human using the script generated by the LLM.

In embodiments, the text response to the user is used to create an audio stream using the voice of the synthesized human selected for the first video segment. As in animated film and short-form video production, the completed audio stream is then used to produce a video segment of the synthesized human performing the audio stream. The audio stream is broken down into smaller segments based on natural language processing (NLP) analysis. Each audio segment is used to produce a video clip of the synthesized human performing the audio segment. Based on the content of the audio, the synthesized human can hold up and demonstrate a product, show the product at different angles, describe various ways of using the product, wear the product on the synthetic head or body, etc. Gestures, expressions, body movements, and so on can be generated and refined to match the appropriate tone and emphases indicated by the audio segment. The audio segments can be sent to multiple processors to increase the rate at which video clips are produced and assembled into a second video segment.

The infographic 300 includes a presenting component 392. The presenting component 392 includes presenting, within the embedded interface 310, the second video segment 390 that was synthesized. The embedded interface displays the assembled video segment performed by the synthetic human in a webpage window, video chat window, etc. In some embodiments, the voice of the synthetic human is heard in a phone call or text chat box. As the user interacts with and responds to the second video segment, the collecting of user input, creating a response, producing audio segments and related video clips, and presentation to the user continues, so that the interaction between the user and the synthetic human appears as natural as two humans interacting within a video chat.

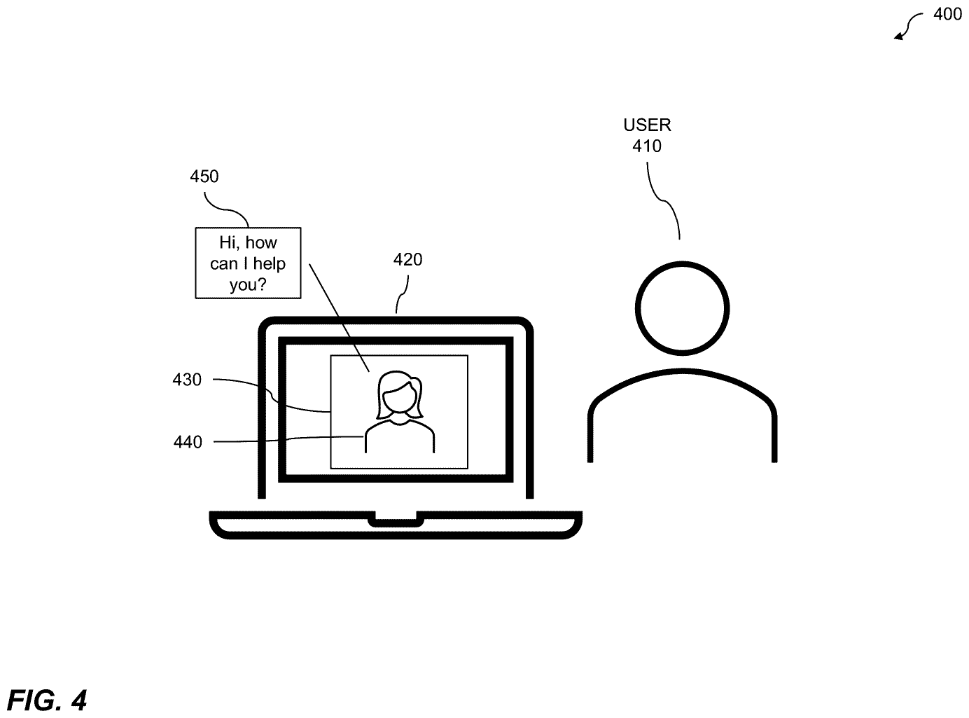

FIG. 4 is an example of displaying a first video segment. The example 400 includes displaying 420, within the embedded interface, a first video segment 430, wherein the first video segment includes a synthetic human 440, and wherein the first video segment initiates the interaction. In embodiments, the user 410 requests the interaction based on a product for sale within the one or more products for sale. As described above and throughout, a user accesses a website with products for sale via an embedded interface. The embedded interface recognizes a user request for an interaction, based on the user clicking on a help button, asking for more information in a video or audio chat, asking a question in a text box, etc. Information about the user is collected based on previous user interactions with the website, demographic data available from the video chat, social media platforms, search engine information, and so on. The user information is used by an AI machine learning model to select a synthetic human to interact with the user through a video chat segment displayed in the embedded interface. In the example 400, the synthetic human is shown saying, “Hi, how can I help you?” 450.

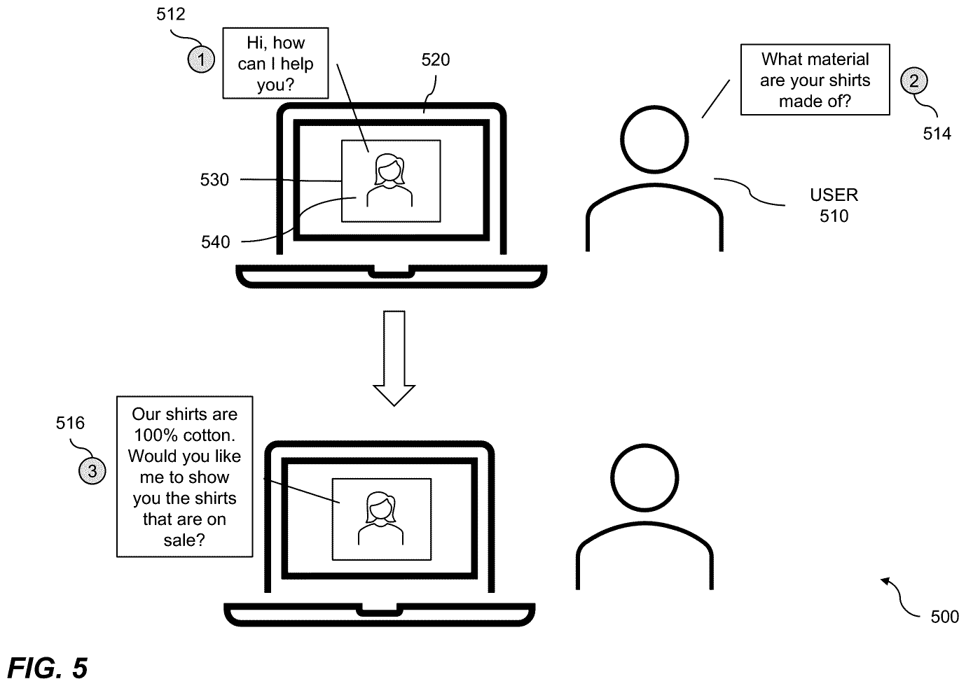

FIG. 5 is an example of an interaction with an artificial intelligence virtual assistant. The example 500 is shown in three stages. In stage 1 512, the example 500 includes requesting, by a user 510, an interaction, wherein the interaction is based on a product for sale within the one or more products for sale. The user accesses a website with products for sale via an embedded interface 520. The embedded interface recognizes a user request for an interaction, based on the user clicking on a help button, asking for more information in a video or audio chat, asking a question in a text box, etc. Information about the user is collected based on previous user interactions with the website, demographic data available from the video chat, social media platforms, search engine information, and so on. The user information is used by an AI machine learning model to select a synthetic human 540 to interact with the user 510 through a first video segment 530 displayed in the embedded interface 520. In the example 500, the synthetic human is shown saying, “Hi, how can I help you?”

In stage 2 514 of the example 500, the user 510 responds to the synthetic human in the first video segment with a question, “What materials are your shirts made of?” The example 500 includes collecting, by the embedded interface 520, the user input. The user input, for example, the question about shirt material, is collected by an AI machine learning model that includes a large language model (LLM) that uses natural language processing (NLP). The AI machine learning model can analyze the user input and generate a response based on information, articles, multimedia files, and so on contained in a dataset. The dataset can be in a SQUAD format. The SQUAD dataset can be formatted to contain hundreds of questions and answers generated from the information articles on products and services offered for sale on the website. The AI machine learning model can analyze the question asked by the user and select the best response based on the product information stored in the dataset.

The example 500 includes creating, by an LLM, a response to the interaction with the user. In stage 3 516 of the example 500, the LLM generates a text response to the user question. The response is, “Our shirts are 100% cotton. Would you like me to show you the shirts that are on sale?” The entire text response is recorded using the same voice of the synthetic human used in the first video segment (Stage 1) to create an audio stream. In embodiments, the audio stream can be edited to include pauses, speaking errors, accents, idioms, and so on to make the audio sound as natural as possible. The audio stream can be separated into segments based on the natural auditory cadence of the stream. Each segment can be used to generate a video clip of the synthetic human performing the audio segment. The audio segments can be sent to one or more separate processors so that each video clip can be generated quickly and reassembled in order to present to the user. In embodiments, the video clips are produced and presented to the user as additional clips are being generated. The user 510 can respond to the second video clip with additional questions, comments, and so on. For example, the user in the example 500 can say, “Yes, please do.” The AI machine learning model can then collect the response from the user and display the shirts on sale from the website. Additional videos of the synthetic human can be generated to discuss additional details of the shirts; inform the user about matching clothing items such as pants, jackets, and accessories; and so on.

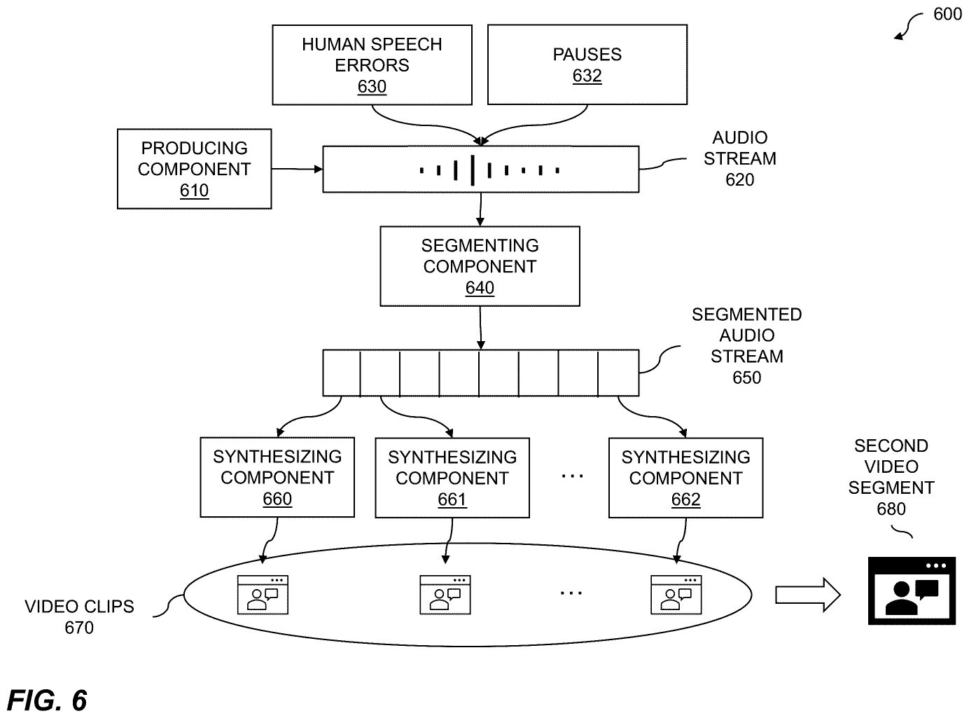

FIG. 6 is an example of processing an audio stream. The example 600 includes a producing component 610. The producing component 610 includes producing a second video segment, wherein the second video segment includes a performance by the synthetic human, wherein the performance includes the response that was created. As mentioned above and throughout, an AI large language model (LLM) can be used to collect and analyze user input based on a product for sale. The user input can be collected in response to a first video segment generated by the AI machine learning model. The user input can be a question or comment collected through a text box, a video chat, a phone call, etc. The user input can be converted into a text stream that can be analyzed by the LLM. The LLM can create a response to the user input based on questions and responses that can be stored in a SQUAD format dataset.

The example 600 includes an audio stream 620. The audio stream 620 is produced with the synthesized voice from the first video segment. The synthesized voice is used to perform the text response to the user created by the LLM. As mentioned above and throughout, the synthesized voice can be based on a voiceprint from a human. The synthesized voice can be based on AI-generated speech, wherein the AI-generated speech includes the response that was created. The producing further comprises adding, to the audio stream, one or more simulations of human speech errors 630, such as repeated words, words in the wrong order, grammar mistakes, and so on. The producing includes adding pauses 632 to the audio stream to simulate human cognitive processing rates, including filler words such as “um”, “ah”, “uh”, and so on. The LLM adds simulations of speech errors and pauses into the user response audio stream in order to match human speech more closely. Filler words are added, words are duplicated at the beginning of phrases, the pace of speech slows down or speeds up slightly during the audio stream, and so on. In embodiments, the number of pauses and errors added to the audio stream is regulated to ensure that the primary content of the response is preserved and communicated to the user.

The example 600 further includes a segmenting component 640. The segmenting component includes segmenting the audio stream, wherein the segmenting is based on a natural language processing (NLP) engine, wherein the segmenting results in a plurality of audio segments in a segmented audio stream 650. In embodiments, the segmenting conforms to a natural auditory cadence. A natural auditory cadence can include the speed at which a typical person speaks sentences and phrases. The responses generated by the LLM for a user interested in purchasing products can be informative and sales oriented in nature and intent. For example, audio emphases can be added to stress the importance of discounts, dates of sales offerings, excitement over new product offerings, and so on. Once the audio stream has been modified to include speech errors and pauses as well, natural language processing (NLP) can be used to break the stream into smaller segments. The segmenting can be based on the auditory cadence of the entire stream. Each sentence of the audio stream can be broken down into smaller sections based on phrasing, pauses, word emphasis, the position of a word in the sentence, and so on. The segmenting can be as incremental as single words which allows the synthesizing of video clips to be completed quickly. In embodiments, the order of the audio segments is recorded so that as the segments are synthesized into video clips, they can be sequenced in the correct order.

The example 600 includes a synthesizing component, which can comprise multiple synthesizing components, indicated as synthesizing component 660, synthesizing component 661, and synthesizing component 662. More synthesizing components can be present, for example, for each segment of the segmented audio stream 650. The synthesizing component 660 includes synthesizing, for each audio segment in the plurality of audio segments, a video clip, wherein the synthesizing results in a plurality of video clips, wherein the second video segment comprises the plurality of video clips that were synthesized. In embodiments, each audio segment of the segmented audio stream 650 is forwarded to a separate processor or group of processors that have a copy of the 3D image of the synthetic human and access to a game engine. The image of the synthetic human can be combined with the synthesized voice and used to generate a video clip of the synthetic human performing the audio segment.

The segmenting and synthesizing of each segment in parallel are critical to real-time communication with the user. For example, if the audio stream were not to be segmented, the synthesis of the second video segment could take 20, 30, 40 seconds or more. Thus, the user would have to wait an unnatural amount of time for a response. Instead, by segmenting the audio stream, many video clips 670 can be produced, limiting compute time. In addition, once the first video clip is ready, it can be shown to the user while other video clips are still processing. Thus, some video clips can be streamed to the user while others are still being synthesized. This method can further reduce the time to produce a response for the user, enabling more natural interactions between the user and synthetic human.

Game engine rig controls can be used to refine face, mouth, lip, and eye movements so that as a word is spoken by the synthetic human, the movement of the mouth, lip, face, and eyes correspond. Thus, the synthetic human appears to be speaking the words contained in the audio segment as naturally as a real human does. Speech errors and pauses added by the LLM are included in the video clip. For example, when the synthetic human pauses to “think” in the midst of a sentence, the eyes look down and to the right or up at the ceiling, along with slight tilts of the head, to simulate the process of thinking. The game engine can be used to generate movements of the synthetic human demonstrating a product, holding up a product, wearing a product, asking additional questions, directing the user to a purchasing webpage, showing a video clip of the product being demonstrated, and so on. As each video clip is completed, it can be placed in sequence, combined with other video clips to form the second video segment 680, or streamed to the user as described above. As video clips are completed, they can be added to the end of the video segment, streamed, or used to form additional video segments in response to user comments and questions as they are collected by the embedded interface.

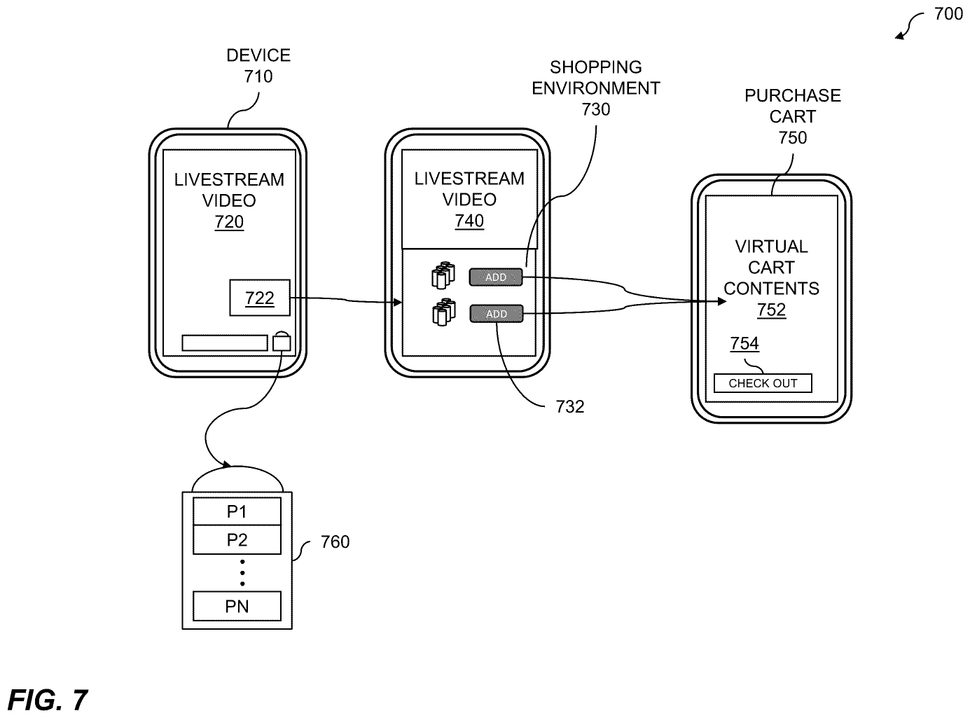

FIG. 7 is an example of an ecommerce purchase environment. As described above and throughout, a website user can interact with a user regarding items for sale. The interaction can include one or more short-form videos that can be accessed and viewed by one or more website users. The short-form video can highlight one or more products available for purchase. An ecommerce purchase can be enabled during a short-form video using an in-frame shopping environment. The in-frame shopping environment can allow internet connected viewers of the short-form video to buy products and services during the short-form video. The short-form video can include an on-screen product card that can be viewed on a CTV device and a mobile device. The in-frame shopping environment or window can also include a virtual purchase cart that can be used by viewers as the short-form video plays.

The example 700 can include a device 710 displaying a short-form video 720. In embodiments, the short-form video can be viewed in real time or replayed at a later time. The device 710 can be a smart TV which can be directly attached to the Internet; a television connected to the Internet via a cable box, TV stick, or game console; an Over-the-Top (OTT) device such as a mobile phone, laptop computer, tablet, pad, or desktop computer; etc. In embodiments, the accessing the short-form video on the device can be accomplished using a browser or another application running on the device.

The example 700 can include generating and revealing a product card 722 on the device 710. In embodiments, the product card represents at least one product available for purchase while the short-form video plays. Embodiments can include inserting a representation of the first object into the on-screen product card. A product card is a graphical element such as an icon, thumbnail picture, thumbnail video, symbol, or other suitable element that is displayed in front of the short-form video. The product card is selectable via a user interface action such as a press, swipe, gesture, mouse click, verbal utterance, or other suitable user action. The product card 722 can be inserted when the short-form video is visible 720. When the product card is invoked, an in-frame shopping environment 730 is rendered over a portion of the short-form video while the short-form video continues to play. This rendering enables an ecommerce purchase 732 by a user while preserving a continuous short-form video playback session. In other words, the user is not redirected to another site or portal that causes the short-form video playback to stop. Thus, viewers are able to initiate and complete a purchase completely inside of the short-form video playback user interface, without being directed away from the currently playing short-form video. Allowing the short-form video event to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

The example 700 can include rendering an in-frame shopping environment 730 enabling a purchase of the at least one product for sale by the viewer, wherein the ecommerce purchase is accomplished within the short-form video window 740. In embodiments, the short-form video window can include a real time short-form video 720 or a prerecorded short-form video segment 740. The enabling can include revealing a virtual purchase cart 750 that supports checkout 754 of virtual cart contents 752, including specifying various payment methods, and applying coupons and/or promotional codes. In some embodiments, the payment methods can include fiat currencies such as United States dollar (USD), as well as virtual currencies, including cryptocurrencies such as Bitcoin. In some embodiments, more than one object (product) can be highlighted and enabled for ecommerce purchase. In embodiments, when multiple items 760 are purchased via product cards during the short-form video, the purchases are cached until termination of the short-form video, at which point the orders are processed as a batch. The termination of the short-form video can include the user stopping playback, the user exiting the video window, the short-form video ending, or a prerecorded short-form video ending. The batch order process can enable a more efficient use of computer resources, such as network bandwidth, by processing the orders together as a batch instead of processing each order individually.

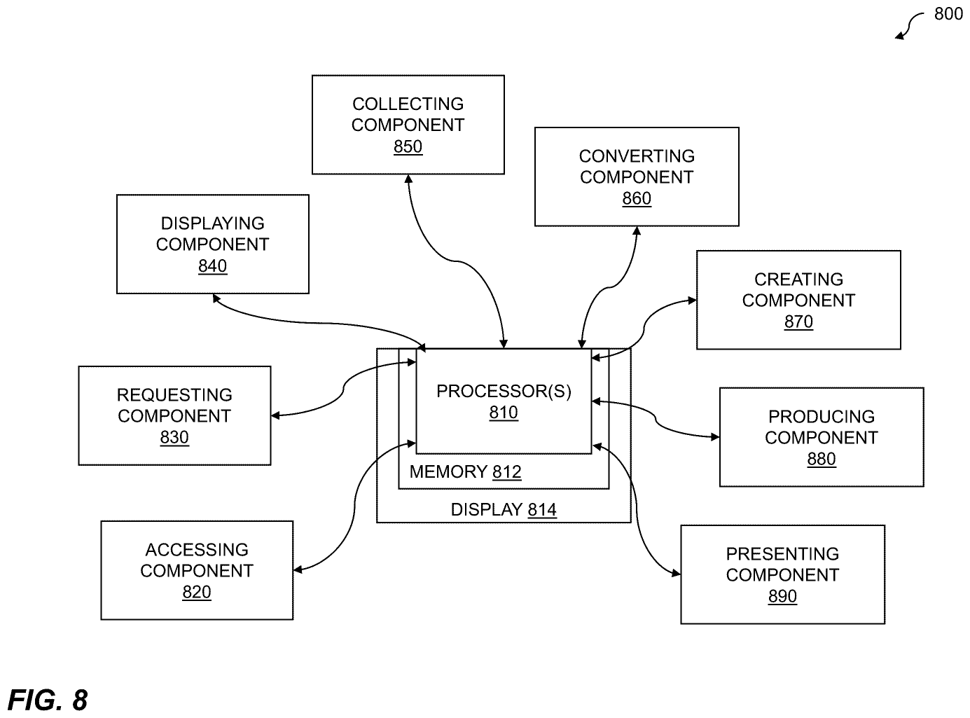

FIG. 8 is a system diagram for an artificial intelligence virtual assistant using large language model processing. The system can include one or more of processors, memories, cache memories, displays, and so on. The system 800 can include one or more processors 810. The processors can include standalone processors within integrated circuits or chips, processor cores in FPGAs or ASICs, and so on. The one or more processors 810 are coupled to a memory 812, which stores operations. The memory can include one or more of local memory, cache memory, system memory, etc. The system 800 can further include a display 814 coupled to the one or more processors 810. The display 814 can be used for displaying data, instructions, operations, and the like. The operations can include instructions and functions for implementation of integrated circuits, including processor cores.

The system 800 includes an accessing component 820. The accessing component 820 includes functions and instructions for accessing an embedded interface, wherein the embedded interface includes one or more products for sale. In embodiments, the embedded interface can comprise a website. The website can be an ecommerce site for a single vendor or brand, a group of businesses, a social media platform, and so on. The website can be displayed on a portable device. The portable device can be an Over-the-Top (OTT) device such as a mobile phone, laptop computer, tablet, or pad. The accessing of the website can be accomplished using a browser running on the device. In embodiments, the embedded interface comprises an app running on a mobile device. The app can use HTTP, TCP/IP, or DNS to communicate with the Internet, web servers, cloud-based platforms, and so on.

The system 800 includes a requesting component 830. The requesting component 830 includes functions and instructions for requesting, by a user, an interaction, wherein the interaction is based on a product for sale within the one or more products for sale. In embodiments, the user can request an interaction by clicking on an icon or button displayed in the embedded interface or on a help button on a webpage, asking for help in a text chat box, navigating to a help desk screen, pressing a phone button during a call, submitting an email to a help desk address, and so on. The user can initiate an interaction from the main webpage of a website, a help menu page, a webpage presenting a specific product, a text or video chatbot embedded in the website, and so on.

The system 800 includes a displaying component 840. The displaying component 840 includes functions and instructions for displaying, within the embedded interface, a first video segment, wherein the first video segment includes a synthetic human, and wherein the first video segment initiates the interaction. In embodiments, the synthetic human can be based on the user information collected by the embedded interface. Images of a live human can be isolated and combined in an AI machine learning model into a 3D model that can be used to generate a video segment in which the synthetic human responds to the user request using answers generated by a large language model (LLM). In embodiments, a game engine can be used to generate a series of animated movements, including basic actions such as sitting, standing, holding a product, presenting a video or photograph, describing an event, and so on. Specialized movements can be programmed and added to the animation as needed. Dialogue can be added so that the face of the presenter moves appropriately as the words are spoken. The result is a performance by the synthetic human, combining animation generated by a game engine and the 3D model of the individual, including the voice of the individual.

The system 800 includes a collecting component 850. The collecting component 850 includes functions and instructions for collecting, by the embedded interface, user input. In embodiments, the user input comprises text. The user can respond to the synthetic human by typing a question or comment into a chat text box. The text box can be generated by the website or the embedded interface window. The user input can comprise audio input. In some embodiments, the audio input is included in a video chat. The user can speak to a video chat window using a mobile phone, pad, tablet, and so on. The collecting component 850 further comprises transforming the audio input into text, wherein the transforming is accomplished with a speech-to-text converter.

The system 800 includes a converting component 860. The converting component 860 includes functions and instructions for converting the user input, wherein the converting results in a dataset, wherein the dataset is readable by a large language model (LLM). In embodiments, the LLM database can include audio and text viewer interactions between the user and the synthetic human. The LLM can include natural language processing (NLP). NLP is a category of artificial intelligence (AI) concerned with interactions between humans and computers using natural human language. In embodiments, the LLM includes NLP to understand the text and the context of voice and text communication during the interaction. The dataset used by the LLM conforms to a SQUAD format.

The system 800 includes a creating component 870. The creating component 870 includes functions and instructions for creating, by the LLM, a response to the interaction with the user. In embodiments, information on products presented on a website can be analyzed by a machine learning model and used to generate answers to questions and comments related to products and services offered for sale. The SQUAD dataset format consists of questions and answers generated from information articles on products and services sold on the website. Responses generated by the LLM provide the appropriate product information stated in a language style and manner consistent with the analysis of the collected user data. In some embodiments, questions that cannot be interpreted by the LLM or that generate answers that have a low likelihood of being correct can be forwarded to a human sales associate, product expert, support staff person, and so on. The human associate can view the question generated by the user and submit an answer to the LLM. The LLM can record the answer in its dataset for future use, as well as submit the answer to the present user.

The system 800 includes a producing component 880. The producing component 880 includes functions and instructions for producing a second video segment, wherein the second video segment includes a performance by the synthetic human, wherein the performance includes the response that was created. In embodiments, the producing is based on a game engine. The game engine can provide common modes of movement for 3D humanoid characters including walking, falling, swimming, crawling, and so on. These default movement modes are built to replicate by default and can be modified by game engine rig controls to create customized movements, such as demonstrating a product. Facial features can be edited to appear more lifelike, including storing unique and idiosyncratic elements of a human face. Articles of clothing can be similarly edited to perform as they do in real life. Voice recordings can be used to generate dialogue with the same vocal qualities used in the first video segment. Volume, pitch, rhythm, frequency, and so on can be manipulated within the game engine to create realistic dialogue for the 3D model of the synthetic human.

In embodiments, the text response to the user is used to create an audio stream using the voice of the synthesized human selected for the first video segment. The audio stream is broken down into smaller segments based on natural language processing (NLP) analysis. Each audio segment is used to produce a video clip of the synthesized human performing the audio segment. The audio segments can be sent to multiple processors to increase the rate at which video clips are produced and assembled into a second video segment.

The system 800 includes a presenting component 890. The presenting component 890 includes functions and instructions for presenting, within the embedded interface, the second video segment that was synthesized. In embodiments, the embedded interface displays the assembled video segment performed by the synthetic human in a webpage window, video chat window, etc. In some embodiments, the voice of the synthetic human is heard in a phone call or text chat box. As the user interacts with and responds to the second video segment, the collecting of user input, creating a response, producing audio segments and related video clips, and presenting to the user continues, so that the interaction between the user and the synthetic human appears as natural as two humans interacting within a video chat.

The system 800 can include a computer program product embodied in a non-transitory computer readable medium for sharing data, the computer program product comprising code which causes one or more processors to perform operations of: accessing an embedded interface, wherein the embedded interface includes one or more products for sale; requesting, by a user, an interaction, wherein the interaction is based on a product for sale within the one or more products for sale; displaying, within the embedded interface, a first video segment, wherein the first video segment includes a synthetic human, and wherein the first video segment initiates the interaction; collecting, by the embedded interface, user input; converting the user input, wherein the converting results in a dataset, wherein the dataset is readable by a large language model (LLM); creating, by the LLM, a response to the interaction with the user; producing a second video segment, wherein the second video segment includes a performance by the synthetic human, wherein the performance includes the response that was created; and presenting, within the embedded interface, the second video segment that was synthesized.

The system 800 can include a computer system for instruction execution comprising: a memory which stores instructions; one or more processors coupled to the memory wherein the one or more processors, when executing the instructions which are stored, are configured to: access an embedded interface, wherein the embedded interface includes one or more products for sale; request, by a user, an interaction, wherein the interaction is based on a product for sale within the one or more products for sale; display, within the embedded interface, a first video segment, wherein the first video segment includes a synthetic human, and wherein the first video segment initiates the interaction; collect, by the embedded interface, user input; convert the user input, wherein the converting results in a dataset, wherein the dataset is readable by a large language model (LLM); create, by the LLM, a response to the interaction with the user; produce a second video segment, wherein the second video segment includes a performance by the synthetic human, wherein the performance includes the response that was created; and present, within the embedded interface, the second video segment that was synthesized.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that runs them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for video processing comprising:
accessing an embedded interface, wherein the embedded interface includes one or more products for sale;
requesting, by a user, an interaction, wherein the interaction is based on a product for sale within the one or more products for sale;
displaying, within the embedded interface, a first video segment, wherein the first video segment includes a synthetic human, and wherein the first video segment initiates the interaction;
collecting, by the embedded interface, user input;
converting the user input, wherein the converting results in a dataset, wherein the dataset is readable by a large language model (LLM);
creating, by the LLM, a response to the interaction with the user;
producing a second video segment, wherein the second video segment includes a performance by the synthetic human, wherein the performance includes the response that was created; and
presenting, within the embedded interface, the second video segment that was synthesized.

2. The method of claim 1 wherein the second video segment includes a synthesized voice for the synthetic human.

3. The method of claim 2 wherein the synthesized voice is based on a voiceprint from a human.

4. The method of claim 2 wherein the synthesized voice is based on AI-generated speech, wherein the AI-generated speech includes the response that was created.

5. The method of claim 4 wherein the AI-generated speech comprises an audio stream.

6. The method of claim 5 further comprising adding, to the audio stream, one or more simulations of human speech errors.

7. The method of claim 5 wherein the audio stream includes pauses to simulate human cognitive processing rates.

8. The method of claim 5 further comprising segmenting the audio stream, wherein the segmenting is based on a natural language processing (NLP) engine, wherein the segmenting results in a plurality of audio segments.

9. The method of claim 8 wherein the segmenting conforms to a natural auditory cadence.

10. The method of claim 8 wherein the producing comprises synthesizing, for each audio segment in the plurality of audio segments, a video clip, wherein the synthesizing results in a plurality of video clips, wherein the second video segment comprises the plurality of video clips that were synthesized.

11. The method of claim 10 wherein the synthesizing is based on phoneme mapping, wherein the phoneme mapping determines a mouth and lip position of the synthetic human.

12. The method of claim 11 wherein the synthesizing includes adding an expression to the synthetic human, wherein the adding is based on one or more patterns of human speech, wherein the one or more patterns of human speech are determined by a deep learning algorithm.

13. The method of claim 1 wherein the producing includes generating, by a generative artificial intelligence model, one or more body movements for the synthetic human.

14. The method of claim 13 further comprising refining the one or more body movements, wherein the refining is based on one or more game engine rig controls.

15. The method of claim 14 further comprising integrating, into the performance by the synthetic human, the one or more body movements that were generated.

16. The method of claim 1 further comprising collecting, from the user, demographic information.

17. The method of claim 16 further comprising customizing an appearance of the synthetic human, wherein the customizing is based on the demographic information that was collected.

18. The method of claim 1 wherein the second video segment comprises highlighting, within the performance by the synthetic human, the product for sale.

19. The method of claim 1 wherein the presenting comprises enabling an ecommerce purchase of the product for sale.

20. The method of claim 1 wherein the user input comprises audio input included in a video chat.

21. The method of claim 20 further comprising transforming the audio input into text, wherein the transforming is accomplished with a speech-to-text converter.

22. The method of claim 1 wherein the creating, the producing, and the presenting include a second interaction.

23. The method of claim 1 wherein the embedded interface comprises an app running on a mobile device.

24. The method of claim 1 wherein the second video segment includes text.

25. A computer program product embodied in a non-transitory computer readable medium for video processing, the computer program product comprising code which causes one or more processors to perform operations of:
accessing an embedded interface, wherein the embedded interface includes one or more products for sale;
requesting, by a user, an interaction, wherein the interaction is based on a product for sale within the one or more products for sale;
displaying, within the embedded interface, a first video segment, wherein the first video segment includes a synthetic human, and wherein the first video segment initiates the interaction;
collecting, by the embedded interface, user input;
converting the user input, wherein the converting results in a dataset, wherein the dataset is readable by a large language model (LLM);
creating, by the LLM, a response to the interaction with the user;
producing a second video segment, wherein the second video segment includes a performance by the synthetic human, wherein the performance includes the response that was created; and
presenting, within the embedded interface, the second video segment that was synthesized.

26. A computer system for video processing comprising:
a memory which stores instructions;
one or more processors coupled to the memory, wherein the one or more processors, when executing the instructions which are stored, are configured to:
access an embedded interface, wherein the embedded interface includes one or more products for sale;
request, by a user, an interaction, wherein the interaction is based on a product for sale within the one or more products for sale;
display, within the embedded interface, a first video segment, wherein the first video segment includes a synthetic human, and wherein the first video segment initiates the interaction;
collect, by the embedded interface, user input;
convert the user input, wherein the converting results in a dataset, wherein the dataset is readable by a large language model (LLM);
create, by the LLM, a response to the interaction with the user;
produce a second video segment, wherein the second video segment includes a performance by the synthetic human, wherein the performance includes the response that was created; and
present, within the embedded interface, the second video segment that was synthesized.
